(19) United States
(12) Patent Application Publication
(10) Pub. No.: US 2022/0178817 A1
(43) Pub. Date: Jun. 9, 2022

(54) Optical Analysis Method and Optical Analysis System

(71) Applicant: Hitachi, Ltd., Chiyoda-ku, Tokyo (JP)

(72) Inventors: Toshimitsu NOGUCHI, Tokyo (JP); Takuya KAMBAYASHI, Tokyo (JP); Shunsuke KONO, Tokyo (JP); Akihiro NOJIMA, Tokyo (JP)

(21) Appl. No.: 17/593,983

(22) PCT Filed: Mar. 18, 2020
(86) PCT No.: PCT/JP2020/012076

§ 371 Date: Sep. 29, 2021

(30) Foreign Application Priority Data
Apr. 15, 2019 (JP) 2019-077133

(51) Int. Cl. G01N 21/31; G01N 1/38

(52) U.S. Cl. CPC G01N 21/31; G01N 1/38

(57) ABSTRACT

An object of the invention is to provide an optical analysis method and an optical analysis system capable of accurately performing an optical analysis by using transmitted light even though a sample contains a turbid substance. The optical analysis method of the present disclosure is an optical analysis method for irradiating a sample s containing a turbid substance in a cell 11 with light and performing optical analysis on the sample s by using transmitted light of the light. The optical analysis method includes: exciting the sample s in the cell 11 by irradiation with ultrasonic waves while adjusting a frequency of the ultrasonic waves such that an intensity of the transmitted light is maximized, and then performing the optical analysis in a state where the sample s is irradiated with ultrasonic waves of this adjusted frequency.

### TECHNICAL FIELD

The present invention relates to an optical analysis method and an optical analysis system.

### BACKGROUND ART

As a method of irradiating a suspended sample with light and analyzing components contained in the sample by using transmitted light transmitted through the sample, for example, an optical analysis method of irradiating a sample with ultrasonic waves is known (for example, see Patent Literature 1).

Such an optical analysis method includes an ultrasonic wave irradiating unit that irradiates ultrasonic waves and a pair of light transparent wall portions that are arranged so as to sandwich a sample, and performs an optical analysis while irradiating the sample with ultrasonic waves having a wavelength longer than a distance between the light transparent wall portions so as to excite the sample.

According to the optical analysis method as described above, a standing wave of ultrasonic wave can be formed in the sample, and suspended matters in the sample are collected in nodes by an acoustic radiation force of ultrasonic wave, and thus an intensity of transmitted light in antinodes can be enhanced and the optical analysis of the sample can be performed.

### CITATION LIST

### Patent Literature

PTL 1: JP-A-2018-96891

### SUMMARY OF INVENTION

### Technical Problem

However, according to the optical analysis in the related art as described above, a sound velocity changes depending on density and temperature, etc. of the sample, and thus the formation of standing wave may be insufficient depending on the components of the sample and a measurement environment, and there is a risk that an intensity of transmitted light suitable for analysis cannot be obtained and the accuracy of analysis is deteriorated.

The invention is made based on the above-mentioned circumstances, and an object of the invention is to provide an optical analysis method and an optical analysis system capable of accurately performing optical analysis by using transmitted light even if a sample contains a turbid substance.

### Solution to Problem

The invention made to solve the above-mentioned problems is an optical analysis method for irradiating a sample containing a turbid substance in a cell with light and performing optical analysis on the sample by using transmitted light of the light. The optical analysis method includes: exciting the sample in the cell by irradiation with ultrasonic waves while adjusting a frequency of the ultrasonic waves such that an intensity of the transmitted light is maximized, and then performing the optical analysis in a state where the sample is irradiated with ultrasonic waves of this adjusted frequency.

Further, another invention made to solve the above-mentioned problems is an optical analysis system configured to irradiate a sample containing a turbid substance in a cell with light and perform optical analysis on the sample by using transmitted light of the light. The optical analysis system includes: a cell into which the sample is to be charged; an ultrasonic wave irradiation device configured to irradiate the sample with ultrasonic waves of a predetermined frequency in order to excite the sample; an optical measurement device including a light source configured to irradiate the sample with light and alight receiver configured to measure an intensity of the transmitted light caused by the light from the light source being transmitted through the sample; and a control device configured to control the ultrasonic wave irradiation device and the optical measurement device based on the intensity of the transmitted light measured by the light receiver. The control device is configured to set a frequency of the ultrasonic waves to be irradiated by the ultrasonic wave irradiation device, determine whether or not the frequency of the irradiated ultrasonic waves is a frequency that maximizes the intensity of the transmitted light, and instruct the optical measurement device to perform optical analysis based on this determination.

In the present description, “light” is a concept that includes visible light and electromagnetic waves other than visible light such ultraviolet light (ultraviolet rays) and infrared light (infrared rays). “Turbid substance” means an element in a sample that scatters light, and refers to, for example, a solid dispersoid (suspended particles) in a suspension, a liquid dispersoid in an emulsion, minute bubbles suspended in a sample, and the like.

### Advantageous Effect

The invention can provide an optical analysis method and an optical analysis system capable of accurately performing optical analysis by using transmitted light even if a sample contains a turbid substance.

### BRIEF DESCRIPTION OF DRAWINGS

FIG. 1A is a schematic diagram for explaining an optical analysis method according to Embodiment 1 of the invention.

FIG. 1B is a schematic diagram when viewed from a direction of arrow A in FIG. 1A.

FIG. 2 is a schematic flowchart showing Embodiment 1.

FIG. 3 is a schematic diagram showing an example of frequency dependency of an intensity of transmitted light.

FIG. 4 is a schematic diagram showing an example of a temporal change in the intensity of transmitted light according to irradiation of ultrasonic waves.

FIG. 5A is a schematic diagram for explaining an optical analysis method according to Embodiment 2 of the invention.

FIG. 5B is a schematic diagram when viewed from a direction of arrow B in FIG. 5A.

FIG. 6 is a schematic flowchart showing Embodiment 2.

FIG. 7 is a schematic block diagram showing an optical analysis system according to Embodiment 3 of the invention.

### DESCRIPTION OF EMBODIMENTS

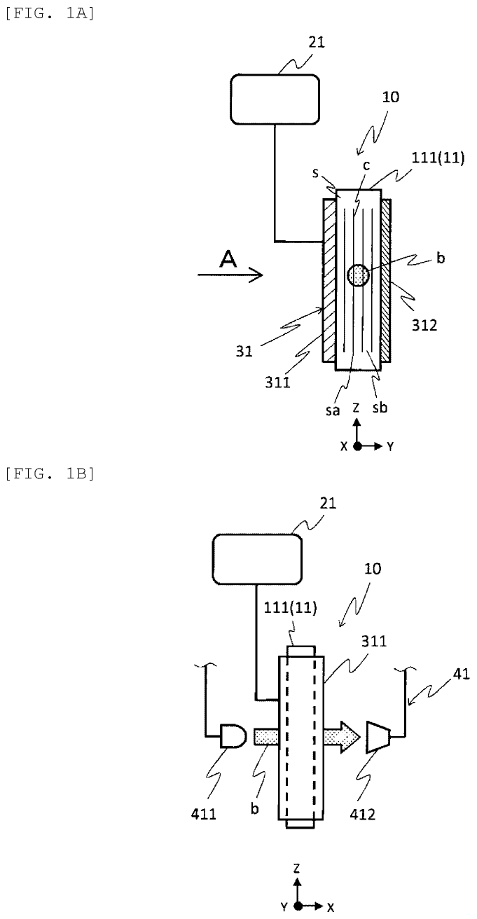

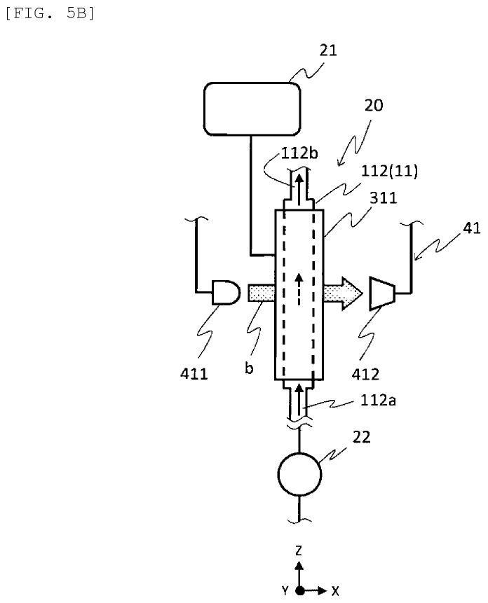

Hereinafter, although embodiments of the invention will be described with reference to the drawings, the invention is not limited to only the embodiments described in these drawings. In addition, in coordinate systems shown in FIGS. 1A, 1B, 5A, and 5B, X and Y directions indicate directions perpendicular to each other in a horizontal plane, and Z direction indicates a vertical direction.

Further, in optical analysis, a maximum value of an intensity of transmitted light with respect to a frequency of ultrasonic waves is always a maximum value among peaks, and thus the description “an intensity of transmitted light is maximum” means that “an intensity of transmitted light is both local maximum and global maximum”.

### Optical Analysis Method

The optical analysis method is an optical analysis method of irradiating a sample containing a turbid substance in a cell with light and performing optical analysis on the sample by using transmitted light of the light. The method includes: exciting the sample in the cell by irradiation with ultrasonic waves while adjusting a frequency of the ultrasonic waves such that an intensity of the transmitted light is maximized, and then performing the optical analysis in a state where the sample is irradiated with ultrasonic waves of this adjusted frequency.

### Embodiment 1

FIG. 1A and FIG. 1B are schematic diagrams for explaining an optical analysis method according to Embodiment 1 of the invention. For example, as shown in FIGS. 1A and 1B, an optical analyzer 10 for implementing an optical analysis method A1 can be schematically constituted by a cell 11, an ultrasonic oscillator 21, an ultrasonic wave irradiation device 31, and an optical measurement device 41.

The cell 11 is a container to be charged with a sample s. The cell 11 of the present embodiment is a batch cell 111. The batch cell 111 is provided with a sample inlet (not shown), and the sample s is charged into and discharged from the batch cell 111 through the inlet.

A material constituting the cell 11 is preferably a material that easily transmits light. Further, the material constituting the cell 11 preferably is chemically stable, has high mechanical strength, and has heat resistance. Examples of the material constituting the cell 11 include a quartz glass, a heat-resistant glass (borosilicate glass), an acrylic resin, and a polycarbonate resin.

The ultrasonic oscillator 21 is a device for driving an ultrasonic vibrator 311 to be described later. The ultrasonic oscillator 21 is an oscillator that can change a frequency of ultrasonic waves to be generated to any value (frequency variable oscillator). In order to be capable of adjusting and confirming a frequency and an amplitude of ultrasonic waves to be oscillated, the ultrasonic oscillator 21 can be connected to, for example, an oscilloscope (not shown).

The ultrasonic wave irradiation device 31 is a device that irradiates the sample s with ultrasonic waves of a predetermined frequency in order to excite the sample s. The ultrasonic wave irradiation device 31 has the ultrasonic vibrator 311 and an ultrasonic wave reflecting plate 312. The ultrasonic vibrator 311 receives an electric signal of a predetermined frequency generated by the ultrasonic oscillator 21 to convert the electric signal into ultrasonic vibration, and irradiates the ultrasonic vibration (ultrasonic waves) toward the sample s in the cell 11. The ultrasonic wave reflecting plate 312 reflects the ultrasonic waves passed through the cell 11 toward the ultrasonic vibrator 311. The ultrasonic vibrator 311 and the ultrasonic wave reflecting plate 312 are arranged to face each other in the horizontal direction (the Y direction in FIG. LA) so as to sandwich the batch cell 111.

Here, the ultrasonic vibrator 311 and/or the ultrasonic wave reflecting plate 312 may be fixed by adhesion or the like so as to be in close contact with an outer surface of the cell 11, or maybe attached in a detachable manner so as to be capable of being in close contact with the outer surface of the cell 11. Further, the ultrasonic vibrator 311 and/or the ultrasonic wave reflecting plate 312 may form a part of the cell 11 and be in close contact with the sample s (not shown).

The optical measurement device 41 includes a light source 411, a light receiver 412, a spectrophotometer (not shown), and an analyzer (not shown). The light source 411 generates light having a predetermined wavelength and irradiates the sample s in the cell 11 with the light (a light beam b). The light receiver 412 receives the transmitted light caused by the light from the light source transmitted through the sample s, and measures and outputs the intensity of the transmitted light. In a horizontal direction (the X direction in FIG. 1B) orthogonal to the direction in which the above-mentioned ultrasonic vibrator 311 and the ultrasonic wave reflecting plate 312 face each other, the light source 411 and the light receiver 412 are arranged to face each other so as to sandwich the cell 11. The spectrophotometer measures the intensity, absorbance, and spectra, etc. of the transmitted light. The analyzer calculates components contained in the sample and concentrations thereof by using the spectra, etc. measured by the spectrophotometer. In addition, the light source 411 and the light receiver 412 may be dedicated to the spectrophotometer and the analyzer, and may use a laser light source and a photodiode for laser light that are not dedicated, or the like.

Here, aggregation of a turbid substance c in the sample s suspended by the irradiation of ultrasonic waves and formation of a transparent region due to the aggregation will be described. The ultrasonic waves radiated from the ultrasonic vibrator 311 into the cell 11 are reflected by an inner wall surface of the cell 11 or the ultrasonic wave reflecting plate 312, and a standing wave is formed in the cell 11 by adjusting the frequency of the ultrasonic oscillator 21 to a specific frequency. When the standing wave is formed, a turbid substance c in the sample s is gathered and aggregated at nodes or antinodes of the standing wave due to an acoustic radiation force of ultrasonic waves, and an aggregation region sa is periodically formed. In this case, a transparent region sb having no turbid substance c or a low concentration of the turbid substance c is formed between the adjacent aggregation regions sa. As a result, the intensity of the transmitted light increases (a light transmittance increases) in the transparent region sb.

The above-mentioned standing wave is formed when a relation represented by the following Formula (1) is satisfied.

L=(v/(2×f))×n (1)

In Formula (1), L indicates a distance between the ultrasonic vibrator 311 and the ultrasonic wave reflecting plate 312, v indicates a sound velocity, f indicates the frequency of the ultrasonic waves, and n indicates a natural number, respectively.

In the above-mentioned Formula (1), the sound velocity v depends on the temperature and density of the sample. Therefore, when the sound velocity v changes, a formation state of the standing wave (presence or absence and period of the standing wave) changes, and the intensity of the transmitted light passing through the same position of the cell changes. Since the distance L depends on the structure of the cell 11 and the distance between the ultrasonic vibrator 311 and the ultrasonic wave reflecting plate 312, it is difficult to change the distance frequently. Therefore, it is expected that an optimum frequency that maximizes the intensity of the transmitted light is searched for by adjusting the frequency of ultrasonic waves, which can be easily changed, and the accuracy of analysis on components and concentrations is improved by performing optical analysis while irradiating the sample with ultrasonic waves of the optimum frequency.

Next, one embodiment of the optical analysis method will be described. In the optical analysis method, adjusting the frequency of ultrasonic waves such that the intensity of transmitted light is maximized preferably includes a step of measuring the intensity of the transmitted light after a predetermined time from the start of the irradiation of ultrasonic waves, a step of determining whether or not the frequency of the irradiated ultrasonic waves is a frequency that maximizes the intensity of the transmitted light, and a step of stopping the irradiation of ultrasonic waves to redisperse the turbid substance c in the sample s or to replace the sample with an unmeasured sample s when the intensity of the transmitted light is not maximum.

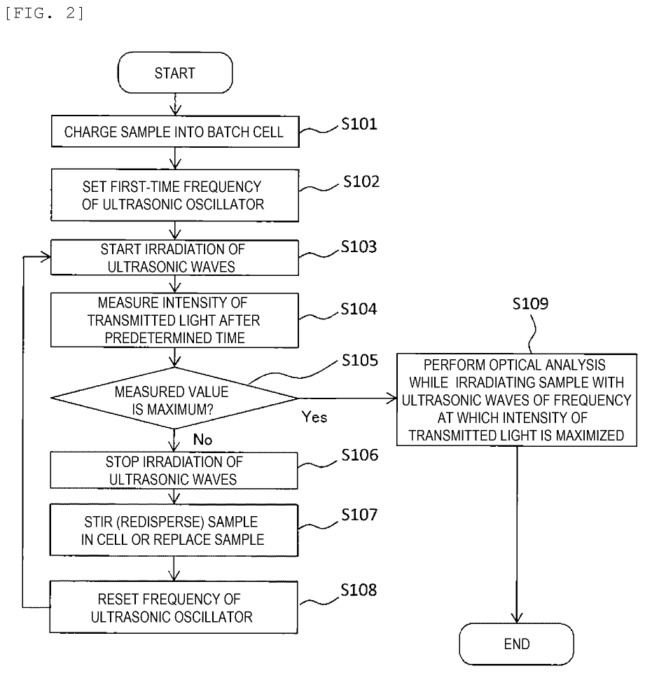

FIG. 2 is a schematic flowchart showing Embodiment 1. As shown in FIG. 2, the optical analysis method A1 is sequentially executed in an order of steps S101, S102, S103, S104, and S105, which will be described later, and after proceeding to step S108, the method is executed again from step S103.

In the optical analysis method A1, in a process of adjusting the frequency of ultrasonic waves such that the intensity of the transmitted light is maximized while exciting the sample in the cell by irradiating with ultrasonic waves, the sample s to be analyzed is first charged into the batch cell 111 (step S101). Next, after setting an initial value of the frequency of the ultrasonic oscillator 21 (step S102), the sample s starts to be irradiated with ultrasonic waves (step S103).

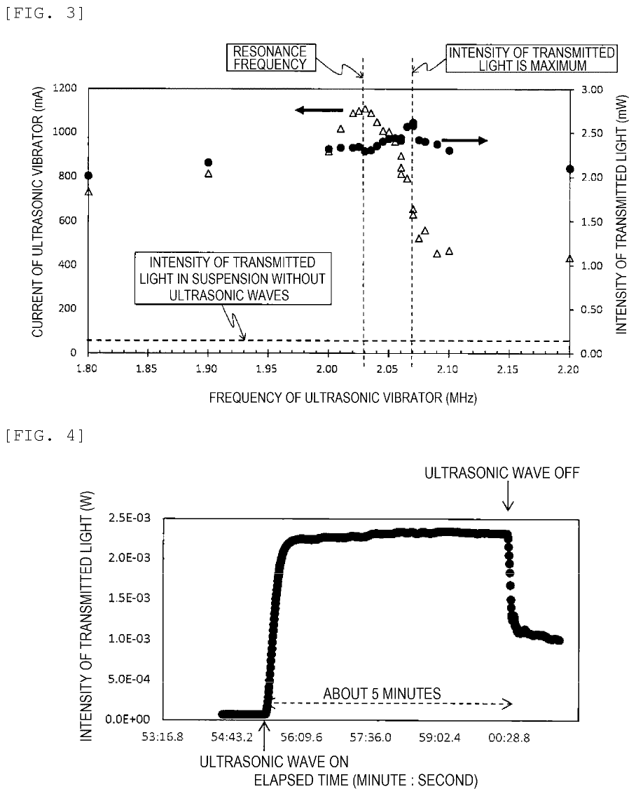

The above-mentioned initial value of the frequency is not particularly limited, but is preferably a resonance frequency of the ultrasonic vibrator 311 (a natural frequency of the ultrasonic vibrator 311) or a frequency in the vicinity thereof from the viewpoint of efficiently searching for an optimum frequency. For example, FIG. 3 is a schematic diagram showing an example of frequency dependency of the intensity of the transmitted light. FIG. 3 shows the intensity of the transmitted light which is measured by using an aqueous solution suspended with polystyrene particles having a particle size of 3 microns (having a particle concentration of about 5×108 particles/mL) as a sample, and irradiating with ultrasonic waves of various frequencies while using a laser beam of 633 nm as the light source 411 and a photodiode type laser power meter as the light receiver 412. In addition, FIG. 3 also shows a current flowing through the ultrasonic vibrator. In this example, it can be seen that a frequency that maximizes the intensity of the transmitted light is in the vicinity of 2.07 MHz, and a resonance frequency of the ultrasonic vibrator 311 (a resonance frequency of the ultrasonic vibrator obtained from the peak of the current) is in the vicinity of 2.03 MHz. Thus, since the frequency that maximizes the intensity of the transmitted light is relatively close to the resonance frequency, the initial value of the frequency set in step S102 maybe, for example, the resonance frequency or a frequency in the vicinity thereof. In addition, when an optimum frequency under the same conditions in the past is known, the initial value of the frequency may be the above-mentioned known frequency or a frequency in the vicinity thereof.

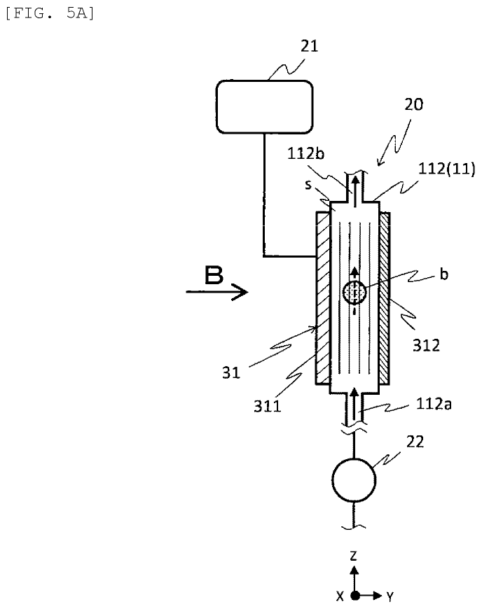

Next, the intensity of the transmitted light is measured after a predetermined time from the start of the irradiation of ultrasonic waves (step S104). The above-mentioned predetermined time means a time after which the intensity of the transmitted light can be regarded as having become stable (a time after which changes can be regarded as negligible). For example, FIG. 4 is a schematic diagram showing an example of a temporal change in the intensity of the transmitted light according to the irradiation of ultrasonic waves. FIG. 4 shows an example of change in the intensity of the transmitted light which is measured by using an aqueous solution suspended with polystyrene particles having a particle size of 3 microns (having a particle concentration of about 5×108 particles/mL) as the sample s, and irradiating with ultrasonic waves of a frequency of 2.07 MHz and using a laser beam of 633 nm as the light source 411 and a photodiode type laser power meter as the light receiver 412. The intensity of the transmitted light increases sharply after the start of the irradiation of ultrasonic waves, and it takes several minutes from the start until the intensity can be regarded as stable. Therefore, it is preferable to measure the intensity of the transmitted light after the predetermined time after which the intensity of the transmitted light can be regarded as having become stable. Accordingly, the intensity of the transmitted light at the frequency to be searched for can be measured more accurately. In addition, it is considered that the reason why it takes time to stabilize the intensity of the transmitted light is that it takes time for the turbid substance c generated by the acoustic radiation force of ultrasonic waves to move.

Next, it is determined whether or not the frequency of the irradiated ultrasonic waves is the frequency that maximizes the intensity of the transmitted light (step S105), and the frequency used when measuring this maximum value is determined as the “frequency that maximizes the intensity of the transmitted light” (hereinafter, this frequency is also referred to as the “optimum frequency”).

Regarding the determination whether or not the intensity of the transmitted light is the maximum value, for example, a relational formula (see Formula (1)) when the standing wave is formed is used, and depending on whether or not a frequency at which the intensity of the transmitted light becomes a local maximum value is in the vicinity of the value of (v/(2×L)×n), it is possible to determine whether or not the local maximum value is the maximum value. Here, v, L and n are synonymous with those in Formula (1). Further, the local maximum value can be found by, for example, observing the intensity of the transmitted light changing from rising to falling when the frequency is changed from a low frequency to a high frequency.

When it is determined that the frequency of ultrasonic waves irradiated in step S105 is the frequency that maximizes the intensity of the transmitted light, a process of adjusting the frequency of the ultrasonic oscillator 21 to the optimum frequency and then performing optical analysis on the sample s in a state where the sample s is irradiated with ultrasonic waves of this adjusted frequency (step S109) is executed and the optical analysis is ended. The optical analysis is not particularly limited as long as being an analysis method of performing measurement using the transmitted light of the sample s, and the analysis can be performed by using a known method. Examples of the optical analysis include UV spectroscopy, vis spectroscopy, near-infrared spectroscopy, mid-infrared spectroscopy, and infrared spectroscopy.

On the other hand, when it is determined that the intensity of the transmitted light is not maximum, the irradiation of ultrasonic waves is stopped (step S106) to redisperse the turbid substance c in the sample s or to replace the sample s with the unmeasured sample s (step S107). In a case where the sample s is to be redispersed, the redispersion of the turbid substance c is performed by, for example, stirring the samples s using instruments such as a magnet stirrer, a stirring rod and a stirring blade (not shown); and swinging the cell 11, repeatedly aspirating and discharging the sample s, blowing in air bubbles, stirring the sample s using an acoustic radiation force of ultrasonic waves, and the like. Therefore, the aggregation of the turbid substance c that remains even after the irradiation of ultrasonic waves is stopped is redispersed so that the sample s can be returned to the initial state. On the other hand, in a case where the sample s is to be replaced, for example, the ultrasonically irradiated sample s is discharged from an outlet of the cell 11, and the unmeasured sample s is charged into the cell 11 through the inlet.

Next, after resetting the frequency of the ultrasonic oscillator 21 (step S108), the frequency that maximizes the intensity of the transmitted light is continuously searched for by repeating from the above-mentioned step S103 again. The frequency after resetting may be, for example, a frequency shifted by a predetermined amount from the frequency measured immediately before.

Thus, since the optical analysis method A1 has the above-mentioned configuration, the optical analysis can be performed by using the ultrasonic waves of the frequency that maximizes the intensity of the transmitted light, and even if the sample s contains the turbid substance c, the optical analysis on the sample s can be performed accurately using the transmitted light. Further, in the analysis method A1, the cell 11 is the batch cell 111, and thus the optical analysis can be easily performed without requiring a large-scale device.

### Embodiment 2

FIG. 5A and FIG. 5B are schematic diagrams for explaining an optical analysis method according to Embodiment 2 of the invention. For example, as shown in FIGS. 5A and 5B, an optical analyzer 20 for implementing an optical analysis method A2 can be schematically constituted by the cell 11, a pump 22, the ultrasonic oscillator 21, the ultrasonic wave irradiation device 31, and the optical measurement device 41. Since the parts other than the cell 11 and the pump 22 are the same as those of the optical analyzer 10 of Embodiment 1, the same parts are indicated by the same reference numerals and detailed descriptions thereof will be omitted.

The cell 11 is a container to be charged with the sample s. The cell 11 of the present embodiment is a flow cell 112. The flow cell 112 is provided with an inlet 112a for the sample s on a bottom surface portion and an outlet 112b for the sample s on a top surface portion, and can be configured such that the sample s charged into the flow cell 112 from the inlet 112a can rise and be discharged from the outlet 112b, so as to, for example, prevent air bubbles from staying.

The pump 22 causes the sample s to flow so as to pass through the flow cell 112. The pump 22 is not particularly limited as long as being capable of causing the sample s to appropriately flow and preventing the sample s from being contaminated. As the pump 22, for example, a tube pump, a peristaltik pump, a syringe pump, a diaphragm pump and the like can be adopted. The pump 22 may be arranged on the inlet 112a side (see FIGS. 5A and 5B) or on the outlet 112b side (not shown).

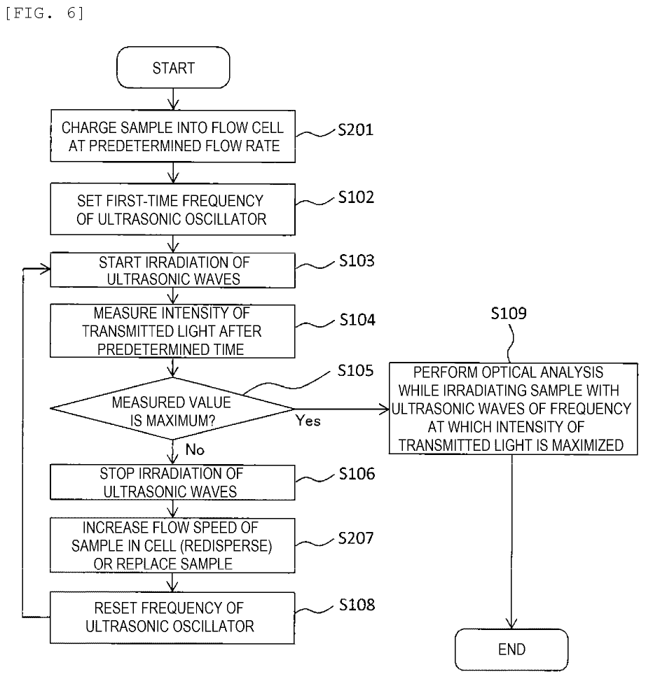

Next, the optical analysis method A2 will be described with reference to FIG. 6. As shown in FIG. 6, the optical analysis method A2 differs from Embodiment 1 by including steps S201 and S207. Since steps S102 to S106 and step S108 are the same as those of the configuration of Embodiment 1, the same steps are indicated by the same reference numerals and detailed descriptions thereof will be omitted.

The optical analysis method A2 is sequentially executed in an order of steps S201, S102, S103, S104, and S105, and after proceeding to step S108, the method is executed again from step S103.

In step S201, the sample s to be analyzed is charged into the flow cell 112. In the present embodiment, the sample s is charged into the flow cell 112 via the inlet 112a by using the pump 22, and the sample s is discharged from the flow cell 112 via the outlet 112b. A flow rate of the sample s can be appropriately set within a range in which the optical analysis is possible.

In step S102, the initial value of the frequency of the ultrasonic oscillator 21 is set. In step S103, the sample s starts to be irradiated with ultrasonic waves. In step S104, the intensity of the transmitted light is measured after a predetermined time from the start of the irradiation of ultrasonic waves.

In step S105, it is determined whether or not the frequency of the irradiated ultrasonic waves is the frequency that maximizes the intensity of the transmitted light. In step S105, when it is determined that the intensity of the transmitted light is maximum, the process of adjusting the frequency of the ultrasonic oscillator 21 to the optimum frequency and then performing optical analysis in a state where the sample s is irradiated with ultrasonic waves of this adjusted frequency (step S109) is executed and the optical analysis is ended. On the other hand, when it is determined that the intensity of the transmitted light is not maximum, the following step S106 is executed.

In step S106, the irradiation of ultrasonic waves is stopped. In step S207, the turbid substance c in the samples is redispersed or replaced with the unmeasured sample. Ina case where the sample s is to be redispersed, the redispersion of the turbid substance c is performed by, for example, stirring the sample s, or setting a flow speed of the sample s in the flow cell 112 higher than the flow speed of the sample s in the flow cell 112 when the intensity of the transmitted light is measured. The above-mentioned stirring can be performed by the same operation as the stirring in Embodiment 1. On the other hand, the operation of increasing the flow speed of the sample s can be specifically performed by, for example, charging (circulating) the sample s discharged from the outlet 112b again into the flow cell 112 from the inlet 112a via a circulation pipe (not shown) in a state where the flow rate of the sample s is increased by the pump 22. In a case where the sample s is to be replaced, for example, the ultrasonically irradiated sample s is discharged from the outlet 112b of the flow cell 112 and is stored in a storage tank (not shown), and the unmeasured sample is charged into the flow cell 112 from the inlet 112a. In step S108, the frequency of the ultrasonic oscillator 21 is reset.

Thus, since the optical analysis method A2 has the above-mentioned configuration, the optical analysis can be performed by using the ultrasonic waves of the frequency that maximizes the intensity of the transmitted light, and even if the sample s contains the turbid substance c, the optical analysis on the sample s can be performed accurately using the transmitted light. Further, in the analysis method A2, since the cell 11 is the flow cell 112, the optical analysis can be performed continuously in real time.

### Optical Analysis System

The optical analysis system of the present disclosure is an optical analysis system that irradiates a sample containing a turbid substance in a cell with light and performs optical analysis on the sample by using transmitted light of the light. The system includes: a cell into which the sample is to be charged; an ultrasonic wave irradiation device that irradiates the sample with ultrasonic waves of a predetermined frequency in order to excite the sample; an optical measurement device including a light source that irradiates the sample with light and a light receiver that measures an intensity of the transmitted light caused by the light from the light source being transmitted through the sample; and a control device that controls the ultrasonic wave irradiation device and the optical measurement device based on the intensity of the transmitted light measured by the light receiver. The control device sets a frequency of the ultrasonic waves to be irradiated by the ultrasonic wave irradiation device, determines whether or not the frequency of the irradiated ultrasonic waves is a frequency that maximizes the intensity of the transmitted light, and instructs the optical measurement device to perform optical analysis based on this determination.

### Embodiment 3

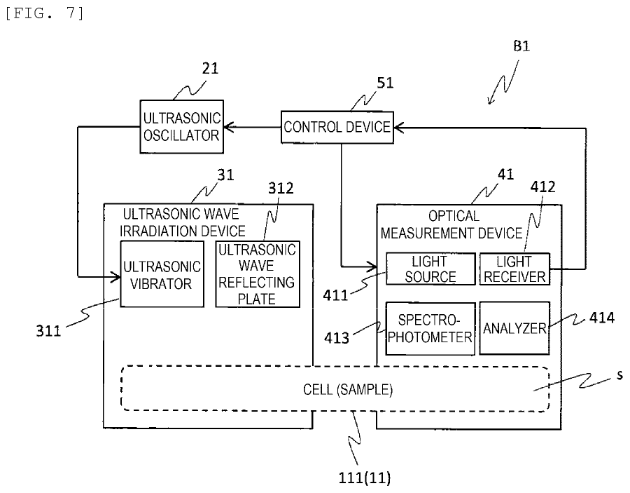

FIG. 7 is a schematic block diagram showing an optical analysis system according to Embodiment 3 of the invention. As shown in FIG. 7, an optical analysis system B1 can be schematically constituted by the cell 11, the ultrasonic oscillator 21, the ultrasonic wave irradiation device 31, the optical measurement device 41, and a control device 51. The cell 11, the ultrasonic oscillator 21, the ultrasonic wave irradiation device 31, and the optical measurement device 41 are the same as those of the configuration of the optical analyzer described in the section <Optical Analysis Method>, and thus the same parts are indicated by the same reference numerals and detailed descriptions thereof will be omitted.

The cell 11 is a container to be charged with the sample s. The cell 11 used in the optical analysis system B1 is not particularly limited as long as the effect of the invention is not impaired, but is preferably the batch cell 111 or the flow cell 112. In a case where the cell 11 is the batch cell 111, the optical analysis can be easily performed without requiring a large-scale device. On the other hand, in a case where the cell 11 is the flow cell 112, the optical analysis can be performed continuously in real time. In the present embodiment, the cell 11 is exemplified by the batch cell 111.

The ultrasonic oscillator 21 is a device for driving the ultrasonic vibrator 311. The ultrasonic wave irradiation device 31 is a device that irradiates the sample s with ultrasonic waves of a predetermined frequency in order to excite the sample s. The ultrasonic wave irradiation device 31 has the ultrasonic vibrator 311 and the ultrasonic wave reflecting plate 312. The optical measurement device 41 includes the light source 411, the light receiver 412, a spectrophotometer 413, and an analyzer 414. The light source 411 irradiates the sample s with light. The light receiver 412 measures the intensity of the transmitted light caused by the light from the light source 411 which is transmitted through the sample s. Further, the light source 411 and the light receiver 412 maybe included in the spectrophotometer 413, or may be provided separately from the spectrophotometer 413 as illustrated.

The control device 51 controls the ultrasonic wave irradiation device 31 and the optical measurement device 41 based on the intensity of the transmitted light measured by the light receiver 412. The control device 51 sets the frequency of the ultrasonic waves to be irradiated by the ultrasonic wave irradiation device 31, determines whether or not the frequency of the irradiated ultrasonic waves is the frequency that maximizes the intensity of the transmitted light, and instructs the optical measurement device 41 to perform optical analysis based on this determination.

Specifically, the control device 51 includes, for example, a personal computer, a display, a data storage device, a signal input/output device, etc. which are not shown. The control device is connected to the light receiver 412, the ultrasonic oscillator 21 and the optical measurement device 41. The personal computer includes a central processing unit (CPU), a memory and the like, and executes various calculations. The display displays input/output information of the personal computer and the like. The data storage device stores software to be executed by the personal computer, information about the ultrasonic wave irradiation device 31 and the optical measurement device 41, and the like (for example, the resonance frequency of the ultrasonic vibrator 311, the frequency of the ultrasonic waves at which the intensity of the transmitted light obtained in the past is maximized, and the like). The signal input/output device receives a signal from the light receiver 412 or the like, or outputs a signal to the ultrasonic oscillator 21, the optical measurement device 41 and the like.

In the setting of the frequency described above, the setting and resetting of the initial value can be performed by using an intensity of the transmitted light signal obtained from the light receiver 412, for example, using the same method as the setting method described in steps S102 and S108 in the section <Optical Analysis Method>. At this time, the initial value of the frequency may be set by using, for example, the resonance frequency of the ultrasonic vibrator 311 stored in the data storage device, a frequency of the ultrasonic waves obtained in the past at which the intensity of the transmitted light is maximized, and the like. A signal regarding the set frequency is output to the ultrasonic oscillator 21.

The above-mentioned determination can be performed, for example, by using the same method as the setting method described in step S105 in the section <Optical Analysis Method>.

The above-mentioned instruction for executing the optical analysis is given by outputting a signal for starting the optical analysis to the optical measurement device 41 when the control device 51 determines that the frequency of the irradiated ultrasonic waves is the frequency that maximizes the intensity of the transmitted light.

Next, a method of using the optical analysis system B1 will be described. Here, a method in which the cell 11 is the batch cell 111 will be illustrated. First, the sample s to be analyzed is charged into the batch cell 111. Next, the control device 51 sets an initial value of the frequency of the ultrasonic oscillator (for example, the same frequency as the resonance frequency of the ultrasonic vibrator 311), and then the ultrasonic wave irradiation device 31 uses an electric signal oscillated by the ultrasonic oscillator 21 to start the irradiation of ultrasonic waves to the sample s. Next, the light receiver 412 starts the irradiation of ultrasonic waves and measures the intensity of the transmitted light after a predetermined time, and then the control device 51 uses the intensity of the transmitted light measured by the light receiver 412 to determine whether or not the frequency of the irradiated ultrasonic waves is the frequency that maximizes the intensity of the transmitted light.

At this case, when the intensity of the transmitted light is determined as maximum, the control device 51 determines the optimum frequency and instructs the optical measurement device 41 to execute the optical analysis. The optical measurement device 41 then performs the optical analysis on the sample s. Further, when the optimum frequency is determined, the control device 51 may indicate “measurement of the frequency at which the intensity of the transmitted light is maximized is completed”, “optical analysis can be started” or the like on the display.

On the other hand, when it is determined that the intensity of the transmitted light is not maximum, the control device 51 stops the oscillation of the ultrasonic oscillator 21 and gives an instruction for stirring the sample s in the batch cell 111 to a stirring device (not shown). Therefore, the sample s is stirred and the turbid substance c is redispersed to the state before the irradiation of ultrasonic waves. Next, the control device 51 resets the frequency, and the ultrasonic wave irradiation device 31 restarts the irradiation of ultrasonic waves to the samples s by using the electric signal oscillated by the ultrasonic oscillator 21. In addition, when the optimum frequency is not determined, the control device 51 suspends the execution of the optical analysis to the optical measurement device 41. In this case, the control device 51 may indicate “measurement of the frequency at which the intensity of the transmitted light is maximized is completed”, “optical analysis cannot be started” or the like on the display.

Thus, since the optical analysis system B1 has the above-mentioned configuration, the optical analysis can be performed by using the ultrasonic waves of the frequency that maximizes the intensity of the transmitted light, and even if the sample s contains the turbid substance c, the optical analysis on the sample s can be performed accurately using the above-mentioned transmitted light.

The invention is not limited to the configurations of the above-mentioned embodiments and is shown by the scope of claims, and is intended to include all modifications within the meaning and scope equivalent to the scope of claims.

For example, the above-mentioned embodiments have described an optical analysis method including a step of starting the irradiation of ultrasonic waves to the sample s and measuring the intensity of the transmitted light after a predetermined time. However, when a rate of change on the intensity of the transmitted light per unit time is correlated with the intensity of the transmitted light after becoming stable, the optimum frequency may be determined based on the rate of change.

Further, the above-mentioned embodiments have described an optical analysis method of adjusting the frequency to the optimum frequency only once in one time of optical analysis. However, when the temperature or density of the sample changes during the optical analysis, since the frequency at which the intensity of the transmitted light is maximized is likely to change during the analysis, the optimum frequency at which the intensity of the transmitted light is maximized may be reset not only before the start of the optical analysis, but also after a predetermined time has passed since the start of optical analysis or at regular time intervals, and the sample may be irradiated with the ultrasonic waves of this reset optimum frequency to continue the optical analysis. In addition, in the optical analysis system, the control device may perform control to reset the optimum frequency at which the intensity of the transmitted light is maximized after a predetermined time or at regular time intervals.

Further, the above-mentioned embodiments have described an optical analysis method proceeding to optical analysis when it is determined that the frequency is the optimum frequency (see steps S105 and S109 in FIGS. 2 and 6). However, the method may measure the intensity of the transmitted light over a wide range of frequency and then determine the optimum frequency and proceed to the optical analysis.

In addition, the above-mentioned embodiments have described an optical analysis method in which the initial value of the frequency is the resonance frequency or a frequency in the vicinity thereof. However, the initial value of the frequency in the ultrasonic oscillator may be set regardless of the resonance frequency of the ultrasonic vibrator.

### INDUSTRIAL APPLICABILITY

The invention can be suitably applied to optical analysis of samples in the form of suspension and emulsion containing a turbid substance for dealing with chemicals, pharmaceuticals, foods, environmental samples, etc.

### REFERENCE SIGN LIST

s sample

c turbid substance

B1 optical analysis system

10, 20 optical analyzer

11 cell

111 batch cell

112 flow cell

31 ultrasonic wave irradiation device

41 optical measurement device

411 light source

412 light receiver

51 control device

1. An optical analysis method for irradiating a sample containing a turbid substance in a cell with light and performing optical analysis on the sample by using transmitted light of the light, the optical analysis method comprising:
exciting the sample in the cell by irradiation with ultrasonic waves while adjusting a frequency of the ultrasonic waves such that an intensity of the transmitted light is maximized, and then performing the optical analysis in a state where the sample is irradiated with ultrasonic waves of this adjusted frequency.

2. The optical analysis method according to claim 1, wherein
adjusting the frequency of ultrasonic waves such that the intensity of the transmitted light is maximized includes:
a step of measuring the intensity of the transmitted light after a predetermined time from a start of the irradiation of ultrasonic waves,
a step of determining whether or not the frequency of the irradiated ultrasonic waves is a frequency that maximizes the intensity of the transmitted light, and
a step of stopping the irradiation of ultrasonic waves to redisperse the turbid substance in the sample or to replace the sample with an unmeasured sample when the intensity of the transmitted light is not maximum.

3. The optical analysis method according to claim 2, wherein
the cell is a batch cell, and the redispersion of the turbid substance is performed by stirring the sample.

4. The optical analysis method according to claim 2, wherein
the cell is a flow cell, and the redispersion of the turbid substance is performed by stirring the sample, or by setting a flow speed of the sample in the cell higher than a flow speed of the sample in the cell when the intensity of the transmitted light is measured.

5. An optical analysis system configured to irradiate a sample containing a turbid substance in a cell with light and perform an optical analysis on the sample by using transmitted light of the light, the optical analysis system comprising:
a cell into which the sample is to be charged;
an ultrasonic wave irradiation device configured to irradiate the sample with ultrasonic waves of a predetermined frequency in order to excite the sample;
an optical measurement device including a light source configured to irradiate the sample with light and alight receiver configured to measure an intensity of the transmitted light caused by the light from the light source being transmitted through the sample; and
a control device configured to control the ultrasonic wave irradiation device and the optical measurement device based on the intensity of the transmitted light measured by the light receiver, wherein
the control device is configured to set a frequency of the ultrasonic waves to be irradiated by the ultrasonic wave irradiation device, determine whether or not the frequency of the irradiated ultrasonic waves is a frequency that maximizes the intensity of the transmitted light, and instruct the optical measurement device to perform optical analysis based on this determination.

6. The optical analysis system according to claim 5, wherein the cell is a batch cell or a flow cell.
